(19) United States
(12) Patent Application Publication
(10) Pub. No.: US 2009/0023624 A1
(43) Pub. Date: Jan. 22, 2009

(54) Detergent compositions

(76) Inventors: Xiaomei Niu, Beijing (CN); Ye Liu, Bejing (CN); Jurgen Carsten Franz Knotzel, Copenhagen (DK); Signe Munk, Charlottenlund (DK)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 11/825,386

(22) Filed: Jul. 6, 2007

(51) Int. Cl. C11D 3/386; C11D 3/08; C11D 17/00

(52) U.S. Cl. 510/298; 510/320; 510/321; 510/323

(57) ABSTRACT

The present invention relates to a detergent composition comprising a new wild-type lipase and variants thereof. In addition a washing method is disclosed.

### CROSS REFERENCE TO RELATED APPLICATIONS

This application claims priority to U.S. Co-Pending patent application filed Jun. 21, 2007, by Niu et al. (P&G Docket No. 10496L, Ser. No. Not Yet Assigned), which claims priority to U.S. Provisional Patent Application Ser. No. 60//830,777 filed Jul. 14, 2006, the disclosure of which is hereby incorporated by reference.

### REFERENCE TO SEQUENCE LISTING

This application contains a Sequence Listing in computer readable form. The computer readable form is incorporated herein by reference.

### REFERENCE TO A DEPOSIT OF BIOLOGICAL MATERIAL

This application contains a reference to a deposit of biological material which have been made at Deutsche Sammlung von Mikroorganismen und Zellkulturen GmbH (DSM) under the Budapest Treaty on 21 Jul. 2005 and assigned accession number DSM 17467 which microbial deposit(s) is incorporated herein by reference.

### FIELD OF THE INVENTION

The present invention relates to detergent compositions comprising isolated polypeptides having lipase activity.

### BACKGROUND OF THE INVENTION

For a number of years, lipases have been used as detergent enzymes to remove lipid or fatty stains from clothes and other textiles (EP 258 068 and EP 305 216).

Patent publications WO 92/05249, WO 94/25577, WO 95/22615, WO 97/04079 and WO 97/07202 disclose variants of the H. lanuginosa lipase having improved properties for detergent purposes. Thus, WO 97/04079 discloses variants having a peptide addition (extension) at the N-terminal and/or the C-terminal. WO 97/07202 discloses lipase variants with “first wash performance” which are capable of removing substantial amounts of lard from a lard stained swatch in a one-cycle wash.

However, there is an ever existing need for providing cleaning compositions comprising novel lipases that, at least in part, improved cleaning properties to such compositions.

### SUMMARY OF THE INVENTION

The present invention relates to a detergent composition comprising an isolated polypeptide having lipase activity selected from the group consisting of:
(a) a polypeptide comprising an amino acid sequence having at least 60% identity to the mature polypeptide of SEQ ID NO: 2;
(b) a polypeptide having an amino acid sequence which has at least 60% identity with amino acids 1 to 315 of SEQ ID NO: 2;
(c) a polypeptide encoded by a polynucleotide that hybridizes under at least low stringency conditions with (i) the mature polypeptide coding sequence of SEQ ID NO: 1, (ii) the cDNA sequence contained in or the genomic DNA sequence comprising the mature polypeptide coding sequence of SEQ ID NO: 1, or (iii) a full-length complementary strand of (i) or (ii);
(d) a polypeptide which is encoded by a polynucleotide which hybridizes under at least low stringency conditions with (i) nucleotides 41 to 1069 of SEQ ID NO: 1, (ii) the cDNA sequence contained in or the genomic DNA sequence comprising nucleotides 41 to 1069 of SEQ ID NO: 1, or (iii) a full-length complementary strand of (i) or (ii);
(d) a polypeptide which is encoded by a polynucleotide which hybridizes under at least low stringency conditions with nucleotides 41 to 1069 of SEQ ID NO: 1, or a complementary strand of nucleotides 41 to 1069 of SEQ ID NO: 1;
(e) a polypeptide encoded by a polynucleotide comprising a nucleotide sequence having at least 60% identity to the mature polypeptide coding sequence of SEQ ID NO: 1;
(f) a polypeptide derived from SEQ ID NO:2 by substitution, deletion or addition of one or more amino acids;
(g) a polypeptide which has at least 60% identity with the polypeptide encoded by the polynucleotide contained in the plasmid which is contained in E. coli DSM 17467.

In a preferred aspect, the mature polypeptide is amino acids 1 to 315 of SEQ ID NO: 2. In another preferred aspect, the mature polypeptide coding sequence is nucleotides 41 to 1069 of SEQ ID NO: 1.

In another aspect, the invention relates to a method of making and using such cleaning compositions.

### DEFINITIONS

Lipase activity: The term “lipase activity” is defined herein as a lipolytic activity which hydrolyses the carboxylic ester bond in glyceryl tributyrate, olein, pNP-butyrate and pNP-palmitate (triacylglycerol lipase, EC 3.1.1.3).

Isolated polypeptide: The term “isolated polypeptide” as used herein refers to a polypeptide which is at least 20% pure, preferably at least 40% pure, more preferably at least 60% pure, even more preferably at least 80% pure, most preferably at least 90% pure, and even most preferably at least 95% pure, as determined by SDS-PAGE.

Substantially pure polypeptide: The term “substantially pure polypeptide” denotes herein a polypeptide preparation which contains at most 10%, preferably at most 8%, more preferably at most 6%, more preferably at most 5%, more preferably at most 4%, at most 3%, even more preferably at most 2%, most preferably at most 1%, and even most preferably at most 0.5% by weight of other polypeptide material with which it is natively associated. It is, therefore, preferred that the substantially pure polypeptide is at least 92% pure, preferably at least 94% pure, more preferably at least 95% pure, more preferably at least 96% pure, more preferably at least 96% pure, more preferably at least 97% pure, more preferably at least 98% pure, even more preferably at least 99%, most preferably at least 99.5% pure, and even most preferably 100% pure by weight of the total polypeptide material present in the preparation.

The polypeptides of the present invention are preferably in a substantially pure form. In particular, it is preferred that the polypeptides are in “essentially pure form”, i.e., that the polypeptide preparation is essentially free of other polypeptide material with which it is natively associated. This can be accomplished, for example, by preparing the polypeptide by means of well-known recombinant methods or by classical purification methods.

Herein, the term “substantially pure polypeptide” is synonymous with the terms “isolated polypeptide” and “polypeptide in isolated form.”Mature polypeptide: The term “mature polypeptide” is defined herein as a polypeptide having lipase activity that is in its final form following translation and any post-translational modifications, such as N-terminal processing, C-terminal truncation, glycosylation, phosphorylation, etc. In a preferred aspect, the mature polypeptide is amino acids 1 to 315 of SEQ ID NO: 2.

Mature polypeptide coding sequence: The term “mature polypeptide coding sequence” is defined herein as a nucleotide sequence that encodes a mature polypeptide having lipase activity. In a preferred aspect, the mature polypeptide coding sequence is nucleotides 41 to 1069 of SEQ ID NO: 1.

Identity: The relatedness between two amino acid sequences or between two nucleotide sequences is described by the parameter “identity”.

In one embodiment and for purposes of the present invention, the alignment of two amino acid sequences is determined by using the Needle program from the EMBOSS package (http://emboss.org) version 2.8.0. The Needle program implements the global alignment algorithm described in Needleman, S. B. and Wunsch, C. D. (1970) J. Mol. Biol. 48, 443-453. The substitution matrix used is BLOSUM62, gap opening penalty is 10, and gap extension penalty is 0.5.

The degree of identity between an amino acid sequence of the present invention (“invention sequence”; amino acids 1 to 343 of SEQ ID NO:2) and a different amino acid sequence (“foreign sequence”) is calculated as the number of exact matches in an alignment of the two sequences, divided by the length of the “invention sequence” or the length of the “foreign sequence”, whichever is the shortest. The result is expressed in percent identity.

An exact match occurs when the “invention sequence” and the “foreign sequence” have identical amino acid residues in the same positions of the overlap (in the alignment example below this is represented by “I”). The length of a sequence is the number of amino acid residues in the sequence (e.g. the length of SEQ ID NO: 2 is 343).

In the alignment example below, the overlap is the amino acid sequence “HTWGER-NL” of Sequence 1; or the amino acid sequence “HGWGEDANL” of Sequence 2. In the example a gap is indicated by a “−”.

### Hypothetical Alignment Example:

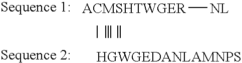

In another embodiment of the invention the degree of identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite (2000). Rice, P., Longden, I., and Bleasby, A. Trends in Genetics 16: 276-277; http://emboss.org), preferably version 3.0.0 or later. The optional parameters used are gap open penalty of 10, gap extension penalty of 0.5, and the EBLOSUM62 (EMBOSS version of BLOSUM62) substitution matrix. The output of Needle labeled “longest identity” (obtained using the—nobrief option) is used as the percent identity and is calculated as follows:

(Identical Residues×100)/(Length of Alignment−Total Number of Gaps in Alignment)

For purposes of the present invention, the degree of identity between two deoxyribonucleotide sequences is determined using the Needleman-Wunsch algorithm (Needleman and Wunsch, 1970, supra) as implemented in the Needle program of the EMBOSS package (EMBOSS: The European Molecular Biology Open Software Suite (2000). Rice, P., Longden, I., and Bleasby, A. Trends in Genetics 16, (6) p 276-277; http://emboss.org), preferably version 3.0.0 or later. The optional parameters used are gap open penalty of 10, gap extension penalty of 0.5, and the EDNAFULL (EMBOSS version of NCBI NUC4.4) substitution matrix. The output of Needle labeled “longest identity” (obtained using the—nobrief option) is used as the percent identity and is calculated as follows:

(Identical Deoxyribonucleotides×100)/(Length of Alignment−Total Number of Gaps in Alignment)

Homologous sequence: The term “homologous sequence” is defined herein as a predicted protein that gives an E value (or expectancy score) of less than 0.001 in a tfasty search (Pearson, W. R., 1999, in Bioinformatics Methods and Protocols, S. Misener and S. A. Krawetz, ed., pp. 185-219) with the mature lipase comprised in SEQ ID NO: 2 or the mature polypeptide encoding sequence comprised in SEQ ID NO: 1 as the case may be.

Polypeptide fragment: The term “polypeptide fragment” is defined herein as a polypeptide having one or more (several) amino acids deleted from the amino and/or carboxyl terminus of the mature polypeptide of SEQ ID NO: 2; or a homologous sequence thereof; wherein the fragment has lipase activity.

Subsequence: The term “subsequence” is defined herein as a nucleotide sequence having one or more (several) nucleotides deleted from the 5′ and/or 3′ end of the mature polypeptide coding sequence of SEQ ID NO: 1; or a homologous sequence thereof; wherein the subsequence encodes a polypeptide fragment having lipase activity.

Allelic variant: The term “allelic variant” denotes herein any of two or more alternative forms of a gene occupying the same chromosomal locus. Allelic variation arises naturally through mutation, and may result in polymorphism within populations. Gene mutations can be silent (no change in the encoded polypeptide) or may encode polypeptides having altered amino acid sequences. An allelic variant of a polypeptide is a polypeptide encoded by an allelic variant of a gene.

Isolated polynucleotide: The term “isolated polynucleotide” as used herein refers to a polynucleotide that is at least 20% pure, preferably at least 40% pure, more preferably at least 60% pure, even more preferably at least 80% pure, most preferably at least 90% pure, and even most preferably at least 95% pure, as determined by agarose electrophoresis.

Substantially pure polynucleotide: The term “substantially pure polynucleotide” as used herein refers to a polynucleotide preparation free of other extraneous or unwanted nucleotides and in a form suitable for use within genetically engineered protein production systems. Thus, a substantially pure polynucleotide contains at most 10%, preferably at most 8%, more preferably at most 6%, more preferably at most 5%, more preferably at most 4%, more preferably at most 3%, even more preferably at most 2%, most preferably at most 1%, and even most preferably at most 0.5% by weight of other polynucleotide material with which it is natively or recombinantly associated. A substantially pure polynucleotide may, however, include naturally occurring 5′ and 3′ untranslated regions, such as promoters and terminators. It is preferred that the substantially pure polynucleotide is at least 90% pure, preferably at least 92% pure, more preferably at least 94% pure, more preferably at least 95% pure, more preferably at least 96% pure, more preferably at least 97% pure, even more preferably at least 98% pure, most preferably at least 99%, and even most preferably at least 99.5% pure by weight. The polynucleotides of the present invention are preferably in a substantially pure form. In particular, it is preferred that the polynucleotides disclosed herein are in “essentially pure form”, i.e., that the polynucleotide preparation is essentially free of other polynucleotide material with which it is natively or recombinantly associated. Herein, the term “substantially pure polynucleotide” is synonymous with the terms “isolated polynucleotide” and “polynucleotide in isolated form.” The polynucleotides may be of genomic, cDNA, RNA, semisynthetic, synthetic origin, or any combinations thereof.

Coding sequence: When used herein the term “coding sequence” means a nucleotide sequence, which directly specifies the amino acid sequence of its protein product.

Expression: The term “expression” includes any step involved in the production of the polypeptide, including, but not limited to, transcription, post-transcriptional modification, translation, post-translational modification, and secretion. cDNA: The term “cDNA” is defined herein as a DNA molecule which lacks intron sequences that are usually present in the corresponding genomic DNA. The cDNA can be prepared by reverse transcription from a mature, spliced, mRNA molecule obtained from a eukaryotic cell. The initial, primary RNA transcript is a precursor to mRNA that is processed through a series of steps before appearing as mature spliced mRNA. These steps include the removal of intron sequences by a process called splicing. cDNA derived from mRNA lacks, therefore, any intron sequences.

Nucleic acid construct: The term “nucleic acid construct” as used herein refers to a nucleic acid molecule, either single- or double-stranded, which is isolated from a naturally occurring gene or which is modified to contain segments of nucleic acids in a manner that would not otherwise exist in nature. The term nucleic acid construct is synonymous with the term “expression cassette” when the nucleic acid construct contains the control sequences required for expression of a coding sequence of the present invention.

Control sequences: The term “control sequences” is defined herein to include all components, which are necessary or advantageous for the expression of a polynucleotide encoding a polypeptide of the present invention. Each control sequence may be native or foreign to the nucleotide sequence encoding the polypeptide or native or foreign to each other. Such control sequences include, but are not limited to, a leader, polyadenylation sequence, propeptide sequence, promoter, signal peptide sequence, and transcription terminator. At a minimum, the control sequences include a promoter, and transcriptional and translational stop signals. The control sequences may be provided with linkers for the purpose of introducing specific restriction sites facilitating ligation of the control sequences with the coding region of the nucleotide sequence encoding a polypeptide.

Operably linked: The term “operably linked” denotes herein a configuration in which a control sequence is placed at an appropriate position relative to the coding sequence of the polynucleotide sequence such that the control sequence directs the expression of the coding sequence of a polypeptide.

Expression vector: The term “expression vector” is defined herein as a linear or circular DNA molecule that comprises a polynucleotide encoding a polypeptide of the invention, and which is operably linked to additional nucleotides that provide for its expression.

Host cell: The term “host cell”, as used herein, includes any cell type which is susceptible to transformation, transfection, transduction, and the like with a nucleic acid construct comprising a polynucleotide of the present invention.

Artificial variant: When used herein, the term “artificial variant” means a polypeptide having lipase activity produced by an organism expressing a modified polynucleotide sequence of the mature polypeptide coding sequence of SEQ ID NO: 1; or a homologous sequence thereof. The modified nucleotide sequence is obtained through human intervention by modification of the polynucleotide sequence disclosed in SEQ ID NO: 1; or a homologous sequence thereof.

### DETAILED DESCRIPTION OF THE INVENTION

### Useful Polypeptides

The ratio of the substrate specificity (pNPC4/C16) of the lipase of the present invention to a known lipase as SEQ ID NO.: 12 may be 0.5.

The lipase of the present invention shows activity in the temperature range from 20° C. to 50° C. with an optimum at 30° C., and an optimum at pH 9. The pH- and thermo-stability test showed that it is stable at pH 10 up to 30 minutes, and the residual activity is 44.7% and 36.1% respectively after incubation at 40° C. for 30 minutes or 50° C. for 20 minutes.

The malodour usually forms under drying conditions subsequent to washing, especially due to cleavage of short-chained glycerides in milk fat. Thus, one way to solve the malodour problem is looking for a first wash lipase which is very active on the long-chained glycerides at high pH (7.0-11.0) but has low activity on short-chained glycerides, for example, triburyrin, at pH 7.0-9.0. The lipase of the present invention showed high lipase activity towards olive oil at pH 10.0 and better substrate specificity (a lower ratio on pNPC4, pH 7.0 to pNPC16) compared with the known lipase of SEQ ID NO.: 12.

Genomic DNA source

The lipase of the present invention may be a lipase purified from the fungal strain Nectria sp. The wild type strain is found on dead branches of unidentified plant, Yunnan Province China in 1999. The strain is deposited on 21 Jul. 2005 under the terms of the Budapest Treaty; the deposit Number is CBS 118130.

The inventors have also cloned the gene into a strain of E. coli and deposited it under the terms of the Budapest Treaty on 21 July 2005 as DSM 17467.

Polypeptides having Lipase Activity

The lipase of the present invention is a lipase which may be purified from the fungal strain Nectria sp.

In one aspect the present invention relates to isolated polypeptides comprising an amino acid sequence having a degree of identity to the mature polypeptide of SEQ ID NO: 2 of preferably at least 60%, more preferably at least 65%, more preferably at least 70%, more preferably at least 75%, more preferably at least 80%, more preferably at least 85%, even more preferably at least 90%, most preferably at least 95%, and even most preferably at least 96%, 97%, 98%, or 99%, which have lipase activity (hereinafter “homologous polypeptides”). In a preferred aspect, the homologous polypeptides have an amino acid sequence that differs by ten amino acids, preferably by five amino acids, more preferably by four amino acids, even more preferably by three amino acids, most preferably by two amino acids, and even most preferably by one amino acid from the mature polypeptide of SEQ ID NO: 2.

In an embodiment the polypeptide of the invention comprises or consists of the mature polypeptide of SEQ ID NO: 2; or a fragment thereof having lipase activity.

In a further aspect, the present invention relates to isolated polypeptides having an amino acid sequence which has a degree of identity to amino acids 1-315 of SEQ ID NO: 2 or with the polypeptide encoded by the polynucleotide contained in the plasmid which is contained in E. coli DSM 17467 (i.e., the mature polypeptide) of at least 60%, preferably at least 65%, more preferably at least 70%, more preferably at least 75%, more preferably at least 80%, more preferably at least 85%, even more preferably at least 90%, such as 91%, or 92%, or 93%, or 94%, most preferably at least 95%, such as 96%, or 97%, or 98%, or 99% (hereinafter “homologous polypeptides”). In a preferred aspect, the homologous polypeptides have an amino acid sequence which differs by ten amino acids, preferably by five amino acids, more preferably by four amino acids, even more preferably by three amino acids, most preferably by two amino acids, and even most preferably by one amino acid from amino acids 1-315 of SEQ ID NO: 2.

In an embodiment the polypeptide of the invention comprises or consists of the amino acids 1 to 315 of SEQ ID NO: 2; or a fragment thereof having lipase activity.

In an embodiment the polypeptide of the invention is encoded by a polynucleotide that hybridizes under at least medium stringency, at least medium-high stringency or at least high stringency conditions with (i) the mature polypeptide coding sequence of SEQ ID NO: 1, (ii) the cDNA sequence contained in or the genomic DNA sequence comprising the mature polypeptide coding sequence of SEQ ID NO: 1, or (iii) a full-length complementary strand of (i) or (ii).

In an embodiment the polypeptide of the invention is encoded by a polynucleotide comprising a nucleotide sequence having at least 65%, 70%, 75%, 80%, 85%, 90% or 95% identity to the mature polypeptide coding sequence of SEQ ID NO: 1

In an embodiment the polypeptide of the invention is encoded by a polynucleotide comprising or consisting of the nucleotide sequence of SEQ ID NO: 1; or a subsequence thereof encoding a fragment having lipase activity.

In an embodiment the polypeptide of the invention is encoded by a polynucleotide comprising or consisting of the mature polypeptide coding sequence of SEQ ID NO: 1.

In an embodiment the polypeptide of the invention is encoded by a polynucleotide comprising or consisting of the nucleotide sequence of SEQ ID NO: 1

In a further aspect, the present invention relates to isolated polypeptides having lipase activity which are encoded by polynucleotides which hybridize under very low stringency conditions, preferably low stringency conditions, more preferably medium stringency conditions, more preferably medium-high stringency conditions, even more preferably high stringency conditions, and most preferably very high stringency conditions with (i) nucleotides 41 to 1069 of SEQ ID NO: 1, (ii) the cDNA sequence contained in nucleotides 41 to 1069 of SEQ ID NO: 1, (iii) a subsequence of (i) or (ii), or (iv) a complementary strand of (i), (ii), or (iii) (J. Sambrook, E. F. Fritsch, and T. Maniatus, 1989, Molecular Cloning, A Laboratory Manual, 2d edition, Cold Spring Harbor, N.Y.). A subsequence of SEQ ID NO: 1 contains at least 100 contiguous nucleotides or preferably at least 200 contiguous nucleotides. Moreover, the subsequence may encode a polypeptide fragment which has lipase activity.

For long probes of at least 100 nucleotides in length, very low to very high stringency conditions are defined as prehybridization and hybridization at 42° C. in 5× SSPE, 0.3% SDS, 200 ug/ml sheared and denatured salmon sperm DNA, and either 25% formamide for very low and low stringencies, 35% formamide for medium and medium-high stringencies, or 50% formamide for high and very high stringencies, following standard Southern blotting procedures for 12 to 24 hours optimally.

For long probes of at least 100 nucleotides in length, the carrier material is finally washed three times each for 15 minutes using 2×SSC, 0.2% SDS preferably at least at 45° C. (very low stringency), more preferably at least at 50° C. (low stringency), more preferably at least at 55° C. (medium stringency), more preferably at least at 60° C. (medium-high stringency), even more preferably at least at 65° C. (high stringency), and most preferably at least at 70° C. (very high stringency).

Under salt-containing hybridization conditions, the effective Tₘ is what controls the degree of identity required between the probe and the filter bound DNA for successful hybridization. The effective Tₘ may be determined using the formula below to determine the degree of identity required for two DNAs to hybridize under various stringency conditions.

Effective Tₘ=81.5+16.6(log M[Na⁺])+0.41(% G+C)−0.72(% formamide)

A 1% mismatch of two DNAs lowers the Tₘ by 1.4° C. To determine the degree of identity required for two DNAs to hybridize under medium stringency conditions at 42° C., the following formula is used:

% Homology=100−[(Effective Tₘ−Hybridization Temperature)/1.4]

In a further aspect, the present invention relates to isolated polypeptides having lipase activity encoded by a polynucleotide comprising nucleotides 41 to 1069 of SEQ ID NO: 1, as a unique motif.

In a further aspect, the present invention relates to artificial variants comprising a conservative substitution, deletion, and/or insertion of one or more of the amino acids 1-315 of SEQ ID NO: 2 or the mature polypeptide thereof. Preferably, amino acid changes are of a minor nature, that is conservative amino acid substitutions or insertions that do not significantly affect the folding and/or activity of the protein; small deletions, typically of one to about 30 amino acids; small amino- or carboxyl-terminal extensions, such as an amino-terminal methionine residue; a small linker peptide of up to about 20-25 residues; or a small extension that facilitates purification by changing net charge or another function, such as a poly-histidine tract, an antigenic epitope or a binding domain.

Examples of conservative substitutions are within the group of basic amino acids (arginine, lysine and histidine), acidic amino acids (glutamic acid and aspartic acid), polar amino acids (glutamine and asparagine), hydrophobic amino acids (leucine, isoleucine and valine), aromatic amino acids (phenylalanine, tryptophan and tyrosine), and small amino acids (glycine, alanine, serine, threonine and methionine). Amino acid substitutions which do not generally alter specific activity are known in the art and are described, for example, by H. Neurath and R. L. Hill, 1979, In, The Proteins, Academic Press, New York. The most commonly occurring exchanges are Ala/Ser, Val/Ile, Asp/Glu, Thr/Ser, Ala/Gly, Ala/Thr, Ser/Asn, Ala/Val, Ser/Gly, Tyr/Phe, Ala/Pro, Lys/Arg, Asp/Asn, Leu/Ile, Leu/Val, Ala/Glu, and Asp/Gly.

The total number of amino acid substitutions, deletions and/or insertions of amino acids of the mature part of SEQ ID NO: 2 is 10, preferably 9, more preferably 8, more preferably 7, more preferably at most 6, more preferably at most 5, more preferably 4, even more preferably 3, most preferably 2, and even most preferably 1.

### Polynucleotides

The present invention also relates to isolated polynucleotides having a nucleotide sequence which encode a polypeptide of the present invention. In a preferred aspect, the nucleotide sequence is set forth in SEQ ID NO: 1. In another more preferred aspect, the nucleotide sequence is the sequence contained in E. Coli DSM 17467. In another preferred aspect, the nucleotide sequence is the mature polypeptide coding region of SEQ ID NO: 1. The present invention also encompasses nucleotide sequences which encode a polypeptide having the amino acid sequence of SEQ ID NO: 2 or the mature polypeptide thereof, which differ from SEQ ID NO: 1 by virtue of the degeneracy of the genetic code. The present invention also relates to subsequences of SEQ ID NO: 1 which encodes fragments of SEQ ID NO: 2 that have lipase activity.

The present invention also relates to mutant polynucleotides comprising at least one difference in the mature polypeptide coding sequence of SEQ ID NO: 1, in which the mutant nucleotide sequence encodes a polypeptide which consists of amino acids of SEQ ID NO: 2.

In an embodiment the isolated polynucleotide of the invention comprises at least one mutation in the mature polypeptide coding sequence of SEQ ID NO: 1, in which the mutant nucleotide sequence encodes the mature polypeptide of SEQ ID NO: 2

In an embodiment the isolated polynucleotide of the invention is obtained by
(a) hybridizing a population of DNA under at least low stringency, at least medium stringency, at least medium-high stringency or at least high stringency conditions with (i) the mature polypeptide coding sequence of SEQ ID NO: 1, (ii) the cDNA sequence contained in or the genomic DNA sequence comprising the mature polypeptide coding sequence of SEQ ID NO: 1, or (iii) a full-length complementary strand of (i) or (ii); and
(b) isolating the hybridizing polynucleotide, which encodes a polypeptide having lipase activity.

The present invention also relates to polynucleotides having nucleotide sequences which have a degree of identity to the mature polypeptide coding sequence of SEQ ID NO: 1 (i.e., nucleotides 41 to 1069) of at least 40, preferably at least 50, preferably at least 60%, preferably at least 65%, more preferably at least 70%, more preferably at least 75%, more preferably at least 80%, more preferably at least 85%, more preferably at least 90%, even more preferably at least 95%, and most preferably at least 97% identity, which encode an active polypeptide.

### Nucleic Acid Constructs

The present invention also relates to nucleic acid constructs comprising an isolated polynucleotide of the present invention operably linked to one or more control sequences which direct the expression of the coding sequence in a suitable host cell under conditions compatible with the control sequences.

An isolated polynucleotide encoding a polypeptide of the present invention may be manipulated in a variety of ways to provide for expression of the polypeptide. Manipulation of the polynucleotide's sequence prior to its insertion into a vector may be desirable or necessary depending on the expression vector. The techniques for modifying polynucleotide sequences utilizing recombinant DNA methods are well known in the art.

The control sequence may be an appropriate promoter sequence, a nucleotide sequence which is recognized by a host cell for expression of a polynucleotide encoding a polypeptide of the present invention. The promoter sequence contains transcriptional control sequences which mediate the expression of the polypeptide. The promoter may be any nucleotide sequence which shows transcriptional activity in the host cell of choice including mutant, truncated, and hybrid promoters, and may be obtained from genes encoding extracellular or intracellular polypeptides either homologous or heterologous to the host cell.

### Expression Vectors

The present invention also relates to recombinant expression vectors comprising a polynucleotide of the present invention, a promoter, and transcriptional and translational stop signals. The various nucleic acids and control sequences described above may be joined together to produce a recombinant expression vector which may include one or more convenient restriction sites to allow for insertion or substitution of the nucleotide sequence encoding the polypeptide at such sites. Alternatively, a nucleotide sequence of the present invention may be expressed by inserting the nucleotide sequence or a nucleic acid construct comprising the sequence into an appropriate vector for expression. In creating the expression vector, the coding sequence is located in the vector so that the coding sequence is operably linked with the appropriate control sequences for expression.

### Host Cells

The present invention also relates to recombinant host cells, comprising a polynucleotide of the present invention, which are advantageously used in the recombinant production of the polypeptides. A vector comprising a polynucleotide of the present invention is introduced into a host cell so that the vector is maintained as a chromosomal integrant or as a self-replicating extra-chromosomal vector as described earlier. The term “host cell” encompasses any progeny of a parent cell that is not identical to the parent cell due to mutations that occur during replication. The choice of a host cell will to a large extent depend upon the gene encoding the polypeptide and its source.

The host cell may be a unicellular microorganism, e.g., a prokaryote, or a non-unicellular microorganism, e.g., a eukaryote.

In a preferred aspect, the host cell is a fungal cell, in particular a fungal cell, such as a yeast cell or a filamentous cell, e.g. a strain of Aspergillus, Fusarium, Trichodenna or Saccharomyces, particularly A. niger, A. oryzae, F. grimnearum or S. cerevisiae.

### Methods of Production

The present invention also relates to methods for producing a polypeptide of the present invention, comprising cultivating a cell, harboring a polynucleotide encoding the polypeptide of the invention, under conditions conducive for production of the polypeptide; and recovering the polypeptide. In an embodiment, the cell is the recombinant host cell of claim. In another embodiment the cell is a wild type cell.

### Compositions

The present invention also relates to compositions comprising a polypeptide of the present invention. Preferably, the compositions are enriched in such a polypeptide. The term “enriched” indicates that the lipase activity of the composition has been increased, e.g., with an enrichment factor of 1.1.

The composition may comprise a polypeptide of the present invention as the major enzymatic component, e.g., a mono-component composition. Alternatively, the composition may comprise multiple enzymatic activities, such as an aminopeptidase, amylase, carbohydrase, carboxypeptidase, catalase, cellulase, chitinase, cutinase, cyclodextrin glycosyltransferase, deoxyribonuclease, esterase, alpha-galactosidase, beta-galactosidase, glucoamylase, alpha-glucosidase, beta-glucosidase, haloperoxidase, invertase, laccase, lipase, mannosidase, oxidase, pectinolytic enzyme, peptidoglutaminase, peroxidase, phytase, polyphenoloxidase, proteolytic enzyme, ribonuclease, transglutaminase, or xylanase. The additional enzyme(s) may be produced, for example, by a microorganism belonging to the genus Aspergillus, preferably Aspergillus aculeatus, Aspergillus awamori, Aspergillus fumigatus, Aspergillus foetidus, Aspergillus japonicus, Aspergillus nidulans, Aspergillus niger, or Aspergillus oryzae; Fusarium, preferably Fusarium bactridioides, Fusarium cerealis, Fusarium crookwellense, Fusarium culmorum, Fusarium graminearum, Fusarium graminum, Fusarium heterosporum, Fusarium negundi, Fusarium oxysporum, Fusarium reticulatum, Fusarium roseum, Fusarium sambucinum, Fusarium sarcochroum, Fusarium sulphureum, Fusarium toruloseum, Fusarium trichothecioides, or Fusarium venenatum; Humicola, preferably Humicola insolens or Humicola lanuginosa; or Trichoderma, preferably Trichoderma harzianum, Trichoderna koningii, Trichoderma longibrachiatum, Trichoderma reesei, or Trichoderma viride.

The polypeptide compositions may be prepared in accordance with methods known in the art and may be in the form of a liquid or a dry composition. For instance, the polypeptide composition may be in the form of a granulate or a microgranulate. The polypeptide to be included in the composition may be stabilized in accordance with methods known in the art.

Examples are given below of preferred uses of the polypeptide compositions of the invention. The dosage of the polypeptide composition of the invention and other conditions under which the composition is used may be determined on the basis of methods known in the art.

### Detergent Ingredients

As used herein detergent compositions include articles and cleaning and treatment compositions. As used herein, the term “cleaning and/or treatment composition” includes, unless otherwise indicated, tablet, granular or powder-form all-purpose or “heavy-duty” washing agents, especially laundry detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use. The compositions can also be in unit dose packages, including those known in the art and those that are water soluble, water insoluble and/or water permeable.

The detergent composition of the present invention can comprise one or more lipase variant(s) of the present invention. In addition to the lipase variant(s), the detergent composition will further comprise a detergent ingredient. The non-limiting list of detergent ingredients illustrated hereinafter are suitable for use in the instant compositions and may be desirably incorporated in certain embodiments of the invention, for example to assist or enhance cleaning performance, for treatment of the substrate to be cleaned, or to modify the aesthetics of the cleaning composition as is the case with colorants, dyes or the like. The precise nature of these additional components, and levels of incorporation thereof, will depend on the physical form of the composition and the nature of the cleaning operation for which it is to be used. Suitable detergent ingredients include, but are not limited to, surfactants, builders, chelating agents, dye transfer inhibiting agents, dispersants, enzymes, and enzyme stabilizers, bleach activators, hydrogen peroxide, sources of hydrogen peroxide, preformed peracids, polymeric dispersing agents, brighteners, suds suppressors, dyes, anti-corrosion agents, tarnish inhibitors, perfumes, fabric softeners, carriers, hydrotropes, processing aids, solvents and/or pigments.

Typical detergents would comprise by weight any combination of the following ingredients: 5-30% surfactant, preferably anionic surfactants such as linear alkylbenzenesulfonate and alcohol ethoxysulfate; 0.005-0.1% protease active protein, wherein the protease is preferably selected from Coronase™, FNA, FN4 or Savinase™, 0.001-0.1% amylase active protein, wherein the amylase is preferably selected from Termamyl™ Natalase™, Stainzyme™ and Purastar™ and 0.1-3% chelants, preferably diethylene triamine pentaacetic acid. For granular and tablet products, such typical detergents would additionally comprise by weight: 5-20% bleach, preferably sodium percarbonate; 1-4% bleach activator, preferably TAED and/or 0-30%, preferably 5-30%, more preferably less than 10% builder, such as the aluminosilicate Zeolite A and/or tripolyphosphate.

Bleaching Agents—The detergent compositions of the present invention may comprise one or more bleaching agents

In general, when a bleaching agent is used, the compositions of the present invention may comprise from about 0.1% to about 50% or even from about 0.1% to about 25% bleaching agent by weight of the subject cleaning composition. Examples of suitable bleaching agents include:

(1) sources of hydrogen peroxide, for example, inorganic perhydrate salts, including alkali metal salts such as sodium salts of perborate (usually mono- or tetra-hydrate), percarbonate, persulphate, perphosphate, persilicate salts and mixtures thereof. In one aspect of the invention the inorganic perhydrate salts are selected from the group consisting of sodium salts of perborate, percarbonate and mixtures thereof. soaps; and

(2) bleach activators having R—(C═O)-L wherein R is an alkyl group, optionally branched, having, when the bleach activator is hydrophobic, from 6 to 14 carbon atoms, or from 8 to 12 carbon atoms and, when the bleach activator is hydrophilic, less than 6 carbon atoms or even less than 4 carbon atoms; and L is leaving group. Examples of suitable leaving groups are benzoic acid and derivatives thereof—especially benzene sulphonate. Suitable bleach activators include dodecanoyl oxybenzene sulphonate, decanoyl oxybenzene sulphonate, decanoyl oxybenzoic acid or salts thereof, 3,5,5-trimethyl hexanoyloxybenzene sulphonate, tetraacetyl ethylene diamine (TAED) and nonanoyloxybenzene sulphonate (NOBS). Suitable bleach activators are also disclosed in WO 98/17767. While any suitable bleach activator may be employed, in one aspect of the invention the subject cleaning composition may comprise NOBS, TAED or mixtures thereof.

(3) Pre-formed peracids.

When present, the peracid and/or bleach activator is generally present in the composition in an amount of from about 0.1 to about 60 wt %, from about 0.5 to about 40 wt % or even from about 0.6 to about 10 wt % based on the composition. One or more hydrophobic precursors thereof may be used in combination with one or more hydrophilic peracid or precursor thereof.

The amounts of hydrogen peroxide source and peracid or bleach activator may be selected such that the molar ratio of available oxygen (from the peroxide source) to peracid is from 1:1 to 35:1, or even 2:1 to 10:1.

Surfactants—The detergent compositions according to the present invention may comprise a surfactant or surfactant system wherein the surfactant can be selected from nonionic surfactants, anionic surfactants, cationic surfactants, ampholytic surfactants, zwitterionic surfactants, semi-polar nonionic surfactants and mixtures thereof. When present, surfactant is typically present at a level of from about 0.1% to about 60%, from about 0.1% to about 40%, from about 0.1% to about 12%, from about 1% to about 50% or even from about 5% to about 40% by weight of the subject composition.

When included therein the detergent will usually contain from about 1% to about 40% of an anionic surfactant such as linear alkylbenzenesulfonate, alpha-olefinsulfonate, alkyl sulfate (fatty alcohol sulfate), alcohol ethoxysulfate, secondary alkanesulfonate, alpha-sulfo fatty acid methyl ester, alkyl- or alkenylsuccinic acid or soap.

The detergent may optionally contain from about 0.2% to about 40% of a non-ionic surfactant such as alcohol ethoxylate, nonylphenol ethoxylate, alkylpolyglycoside, alkyldimethylamineoxide, ethoxylated fatty acid monoethanolamide, fatty acid monoethanolamide, polyhydroxy alkyl fatty acid amide, or N-acyl N-alkyl derivatives of glucosamine (“glucamides”).

Builder—The detergent compositions of the present invention may comprise one or more detergent builders or builder systems. When a builder is used, the subject composition will typically comprise at least about 1%, from about 5% to about 60% or even from about 10% to about 40% builder by weight of the subject composition. Builders include, but are not limited to, the alkali metal, ammonium and alkanolammonium salts of polyphosphates, alkali metal silicates or layered silicates, alkaline earth and alkali metal carbonates, aluminosilicate builders and the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricaboxylic acid, carboxymethyloxysuccinic acid, and soluble salts thereof.

Chelating Agents—The detergent compositions herein may contain a chelating agent. Suitable chelating agents include copper, iron and/or manganese chelating agents and mixtures thereof. When a chelating agent is used, the subject composition may comprise from about 0.005% to about 15% or even from about 3.0% to about 10% chelating agent by weight of the subject composition.

Brighteners—The detergent compositions of the present invention can also contain additional components that may alter appearance of articles being cleaned, such as fluorescent brighteners. These brighteners absorb in the UV-range and emit in the visible. Suitable fluorescent brightener levels include lower levels of from about 0.01, from about 0.05, from about 0.1 or even from about 0.2 wt % to upper levels of 0.5 or even 0.75 wt %.

Dispersants—The compositions of the present invention can also contain dispersants. Suitable water-soluble organic materials include the homo- or co-polymeric acids or their salts, in which the polycarboxylic acid comprises at least two carboxyl radicals separated from each other by not more than two carbon atoms.

Enzymes—In addition to the lipase variant(s) of the present invention the detergent composition can comprise one or more further enzymes which provide cleaning performance and/or fabric care benefits such as a protease, another lipase, a cutinase, an amylase, a carbohydrase, a cellulase, a pectinase, a mannanase, an arabinase, a galactanase, a xylanase, an oxidase, e.g., a laccase, and/or a peroxidase.

In general the properties of the chosen enzyme(s) should be compatible with the selected detergent, (i.e. pH-optimum, compatibility with other enzymatic and non-enzymatic ingredients, etc.), and the enzyme(s) should be present in effective amounts.

Suitable proteases include those of animal, vegetable or microbial origin. Microbial origin is preferred. Chemically modified or protein engineered mutants are included. The protease may be a serine protease or a metallo protease, preferably an alkaline microbial protease or a trypsin-like protease. Examples of alkaline proteases are subtilisins, especially those derived from Bacillus, e.g., subtilisin Novo, subtilisin Carlsberg, subtilisin 309, subtilisin 147 and subtilisin 168 (described in WO 89/06279), SEQ ID no 4 and SEQ ID no 7 in WO 05/103244. Other suitable serin proteases include those from Micrococcineae spp especially Cellulonas spp and variants thereof as disclosed in WO 2005/052146. Examples of trypsin-like proteases are trypsin (e.g. of porcine or bovine origin) and the Fusarium protease described in WO 89/06270 and WO 94/25583.

Examples of useful proteases are the variants described in WO 92/19729, WO 98/20115, WO 98/20116, and WO 98/34946, especially the variants with substitutions in one or more of the following positions: 27, 36, 57, 68, 76, 87, 97, 101, 104, 106, 120, 123, 167, 170, 194, 206, 218, 222, 224, 235, 245, 252 and 274, and amongst other variants with the following mutations: (K27R, V104Y, N123S, T124A), (N76D, S103A, V1041), or (S101G, S103A, V1041, G159D, A232V, Q236H, Q245R, N248D, N252K). Other examples of useful proteases are the variants described in WO 05/052146 especially the variants with substitutions in one or more of the following positions: 14, 16, 35, 65, 75, 76, 79, 123, 127, 159 and 179.

Preferred commercially available protease enzymes include Alcalase™, Savinase™, Primase™, Duralase™, Esperase™, Coronase™, Polarzyme™ and Kannase™ (Novozymes A/S), Maxatase™, Maxacal™, Maxapem™, Properase™, Purafect™, Purafect Prime™, Purafect OxP™, FNA, FN2, FN3 and FN4 (Genencor International Inc.).

Lipases include those of bacterial or fungal origin. Chemically modified or protein engineered mutants are included. Examples of useful lipases include lipases from Humicola (synonym Thermomyces), e.g. from H. lanuginosa (synonymous T. lanuginosus) as described in EP 258 068 and EP 305 216 or from H. insolens as described in WO 96/13580, a Pseudomonas lipase, e.g. from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g. from B. subtilis (Dartois et al. (1993), Biochemica et Biophysica Acta, 1131, 253-360), B. stearothermophilus (JP 64/744992) or B. pumilus (WO 91/16422).

Other examples are lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079 and WO 97/07202.

Other commercially available lipase enzymes include Lipolas™, Lipolase Ultra™ and Lipex™ (Novozymes A/S).

Suitable amylases (α and/or β) include those of bacterial or fungal origin. Chemically modified or protein engineered mutants are included. Amylases include, for example, α-amylases obtained from Bacillus, e.g. a special strain of B. licheniformis, described in more detail in GB 1,296,839.

Examples of useful amylases are the variants described in WO 94/02597, WO 94/18314, WO 96/23873, and WO 97/43424, especially the variants with substitutions in one or more of the following positions: 15, 23, 105, 106, 124, 128, 133, 154, 156, 181, 188, 190, 197, 202, 208, 209, 243, 264, 304, 305, 391, 408, and 444.

Commercially available amylases are Duramyl™, Termamyl™, Stainzyme™, Stainzyme Ultra™, Fungamyl™ and BAN™ (Novozymes A/S), Rapidase™ and Purastar™ (from Genencor International Inc.).

Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g. the fungal cellulases produced from Humicola insolens, Myceliophthora thermophila and Fusarium oxysporum disclosed in U.S. Pat. No. 4,435,307, U.S. Pat. No. 5,648,263, U.S. Pat 5,691,178, U.S. Pat. No. 5,776,757 and WO 89/09259.

Especially suitable cellulases are the alkaline or neutral cellulases having colour care benefits. Examples of such cellulases are cellulases described in EP 0 495 257, EP 0 531 372, WO 96/11262, WO 96/29397, WO 98/08940. Other examples are cellulase variants such as those described in WO 94/07998, EP 0 531 315, U.S. Pat. No. 5,457,046, U.S. Pat. No. 5,686,593, U.S. Pat. 5,763,254, WO 95/24471, WO 98/12307 and PCT/DK98/00299.

Commercially available cellulases include Renozyme™, Celluclean™, Endolase™, Celluzyme™, and Carezyme™ (Novozymes A/S), Clazinase™, and Puradax HA™ (Genencor International Inc.), and KAC-500(B)™ (Kao Corporation).

### Peroxidases/Oxidases:

Suitable peroxidases/oxidases include those of plant, bacterial or fungal origin. Chemically modified or protein engineered mutants are included. Examples of useful peroxidases include peroxidases from Coprinus, e.g. from C. cinereus, and variants thereof as those described in WO 93/24618, WO 95/10602, and WO 98/15257.

Commercially available peroxidases include Guardzyme™ (Novozymes A/S). When present in a cleaning composition, the aforementioned enzymes may be present at levels from about 0.00001% to about 2%, from about 0.0001% to about 1% or even from about 0.001% to about 0.5% enzyme protein by weight of the composition.

Enzyme Stabilizers—Enzymes for use in detergents can be stabilized by various techniques. The enzymes employed herein can be stabilized by the presence of water-soluble sources of calcium and/or magnesium ions in the finished compositions that provide such ions to the enzymes. Further conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid, may also be used and the composition may be formulated as described in e.g. WO 92/19709 and WO 92/19708.

Solvents—Suitable solvents include water and other solvents such as lipophilic fluids. Examples of suitable lipophilic fluids include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

### Washing Method

The present invention includes a method for cleaning and/or treating a situs inter alia a surface or fabric. Such method includes the steps of contacting an embodiment of Applicants' cleaning composition, in neat form or diluted in a wash liquor, with at least a portion of a surface or fabric then optionally rinsing such surface or fabric. The surface or fabric may be subjected to a washing step prior to the aforementioned rinsing step. For purposes of the present invention, washing includes but is not limited to, scrubbing, and mechanical agitation. As will be appreciated by one skilled in the art, the cleaning compositions of the present invention are ideally suited for use in laundry applications. Accordingly, the present invention includes a method for laundering a fabric. The method comprises the steps of contacting a fabric to be laundered with a said cleaning laundry solution comprising at least one embodiment of Applicants' cleaning composition, cleaning additive or mixture thereof. The fabric may comprise most any fabric capable of being laundered in normal consumer use conditions. The solution preferably has a pH of from about 8 to about 10.5. The compositions may be employed at concentrations of from about 100 ppm, preferably 500 ppm to about 15,000 ppm in solution. The water temperatures typically range from about 5 ° C. to about 90 ° C. The invention may be particularly beneficial at low water temperatures such as below 30° C. or below 25 or 20° C. The water to fabric ratio is typically from about 1:1 to about 30:1.

### EXAMPLES

Chemicals used as buffers and substrates are commercial products of at least reagent grade.

### Media and Solutions

### Fungal Strain:

Nectria sp is a mesophilic strain isolated from plant samples and with good growth in media at neutral pH.

### Media for Fungal Growth

YS-25 with the following composition: 1 L medium contained 10 g peptone, 10 g yeast extract, 5 g glucose, 5 g K₂HPO₄, 1 g MgSO₄×7H₂O and 20 ml olive oil. After the pH is adjusted to 6.5, the medium is autoclaved at 121□ for 20 minutes.

### Substrates

Olive oil, Tributyrin, pNP-palmitate, pNP-butyrate

### Chemicals

Agar, Triton X-100, gum Arabic, sodium phosphate, Citric acid, PVA, Brilliant green, Ariel colour compact (CHN-2003-00294), Tris-HCl, PMSF and EDTA.

### Example 1

### The Production of the Lipase of the Present Invention Cloned from Nectria strain

### Material and Method

Materials:

Oligonucleotide primers for polymerase chain reaction (PCR) are custom-made by Shanghai Sangon Biological Engineering & Technology and Service Co. ltd. The RNeasy Mini Kit is purchased from Qiagen company. The Taq DNA polymerase from Fermentas company. The pGEM-T Vector System I and Wizard Plus Minipreps DNA Purification System are purchased from Promega company. The 3′ Rapid Amplifiction of cDNA End System and HIFI Taq DNA polymerase are purchased from Invitrogen company. DNA Walking SpeedUp Kit is purchased from Seegene. The DNA Marker: 100 bp DNA ladder, is purchased from New England Biolab.

Fungal Strain:

Nectria sp. strain is isolated from China

Fermentation and Mycelium Harvesting:

4-6 agar plugs with fully grown fungal cultures on the PDA plates are used to inoculate one shake flask with YS-25 medium with olive oil and incubated under room temperature, 160 rpm for 144 hours. Mycelium is harvested by filtering against miracloth and squeezing dry. It is quickly frozen in liquid N2 and stored at −80° C.

Gene Cloning:

1. Primer design 1.1. Primers designed based on n-terminal sequence:

Two degenerate primers is designed based on N-terminal sequence of the lipase of the present invention: AVTVTSQNLANFKFY VQHAT

(SEQ ID NO.: 8)

Lipase n1:
5′ ca(ag) aa(tc) (ct)tn gcn aa(tc) tt 3′

(SEQ ID NO.: 9)

Lipase n2:
5′ aa(tc) tt(tc) ta(tc) gtn ca(ag) ca(tc) gc 3′

1.2. Reverse(antisense) primers designed based on the conserved region of fusarium lipases

(SEQ ID NO.: 10)

| | |
|---|---|
| lipFDR1: | 5′ agg ttg gc(ag) gc(ag) ccc tca ca 3′ |

(SEQ ID NO.: 11)

| | |
|---|---|
| lipFDR2: | 5′ g(at)(at) gtg tgc c(gt)g tat cca aa 3′ |

2. Total RNA preparation and cDNA synthesis

The total RNA is isolated by using the RNeasy Mini Kit. The cDNA is synthesized by following the instruction of 3′ Rapid Amplifiction of cDNA End System (3′ RACE). 3. PCR amplification:

3.1 partial gene cloning The first PCR is performed by using lipase-ni and AUAP (5′-GGCCACGCGTCG ACTAGTAC -3′, supplied by 3′ RACE kit) as primer pair and cDNA as template. The detailed the procedure is:

| | |
|---|---|
| 10x PCR buffer | 5 ul |
| 25 mM MgCl2 | 3 ul |
| 10 mM dNTP | 1 ul |
| 100 uM lipase-1 n1 | 1 ul |
| cDNA | 2 ul |
| Taq | 1 ul |
| H2O | 36 ul |

First step: without the reverse primer AUAP, after 94° C. for 3 min., 4 cycles of 94° C. for 40 secs, 42° C. for 1 min. and 72° C. for 1 min.

Second step: with the addition of 1 ul of denatured AUAP (95° C. for 5 mins and leaving on ice), 35 cycles of 94° C. for 40 secs, 48° C. for 40 secs and 72° C. for 1 min, final extension at 72° C. for 10 mins.

The nested PCR is performed by using primer pair lipase-n1 and lipFDR1 and the first PCR solution as template.

| | |
|---|---|
| 10x PCR buffer | 5 ul |
| 25 mM MgCl2 | 3 ul |
| 10 mM dNTP | 1 ul |
| 100 uM lipase-n1 | 1 ul |
| 100 uM lipFDR1 | 1 ul |
| 100x diluted 1st PCR solution | 5 ul |
| Taq | 1 ul |
| H₂O | 36 ul |

The PCR program as: 94° C. for 3 mins; 35 cycles of 94 ° C. for 40 secs, 50° C. for 40 secs, 72° C. for 1 min; final extension at 72° C. for 10 mins.

A specific amplification at ˜700 base pairs is recovered from gel and directly sequenced. It is confirmed to be a lipase. Based on this partial sequence, new primers are designed for 5′ end cloning (coding region for signal and propeptide):

(SEQ ID NO.: 3)

| | |
|---|---|
| Lipase-as1: | 5′ tcc aga cga agt cga ggt ttg tga 3′ |

(SEQ ID NO.: 4)

| | |
|---|---|
| Lipase-as2: | 5′ tac tgc cac gga tag aga cga caa 3′ |

(SEQ ID NO.: 5)

| | |
|---|---|
| Lipase-as3: | 5′ aat gcc cgt atc ctc gcc tcc gaa 3′ |

3.2 5′ end cloning

For 5′ end cloning, the DW-ACP (DNA Walking—Annealing Control Primer) PCR is performed with the DNA Waking SpeedUp kit. The first PCR is performed with primer pair lipase-as1 with 4 DW-ACP primers: DW-ACP1,2,3,4 (supplied by DNA Waking SpeedUp kt) separately.

| | |
|---|---|
| DW-ACP1: | 5′-ACP-AGGTC- 3′ |
| DW-ACP2: | 5′-ACP-TGGTC- 3′ |
| DW-ACP3: | 5′-ACP-GGGTC- 3′ |
| DW-ACP4: | 5′-ACP-CGGTC- 3′ |

The PCR program is: 1 cycle of 94° C. for 5 mins, 42° C. for 1 min, 72° C. for 3 mins; 35cycles of 94° C. for 40 secs, 55° C. for 40 secs and 72° C. for 45 secs; final extension at 72° C. for 7 mins.

Nested PCR is performed with primer pair lipase-as2 and the Universal primer ( 5′-TCA CAG AAG TAT GCC AAG CGA-3′, supplied by DNA Waking SpeedUp kt), and 100× diluted 1st PCR solution as template. The PCR program is 94° C. for 3 mins, 10 cycles of 94° C. for 40 secs, 65° C. for 40 secs (decrease 1° C. per cycle) and 72° C. for 45 secs; 29 cycles of 94° C. for 40 secs, 55° C. for 40 secs and 72° C. for 45 secs; final extension at 72° C. for 10 mins.

A specific amplification of about 1 kb is obtained from the nested PCR by lipase-as2 and universal primer as primer pairs and 1st PCR solution (by DW-ACP4 and lipase-as1) as template. It is identified as the 5′ end of lipase. Then the 5′ end primers are designed for full length cloning:

(SEQ ID NO.: 6)

| | |
|---|---|
| lipase-s00: | 5′ aac agg acc cct aga ctt gtg t 3′ |

(SEQ ID NO.: 7)

| | |
|---|---|
| lipase-s01: | 5′ taa ctc tcc tga ttc tca ca 3′ |

3.3 Full length cloning from cDNA

Finally, the full length gene is cloned by PCR with lipase-se00 and AUAP by using HIFI Taq DNA polymerase. The PCR program was: 94° C., 3 mins; 10 cycles of 94° C. for 40 secs, 60° C. 40 secs with 1° C. decrease per cycle, 72° C. for 1 min; 20 cycles of 94° C. for 40 secs, 50° C. for 40 secs, 72° C. for 1 min; final extension at 72° C. for 10 mins. A specific fragment at 1.2 kb is amplified. It is identified as a lipase.

The obtained PCR fragment is cloned into pGEM-T vector and transformed into E.coli DH10B. The positive clones are selected for plasmid preparation for sequencing.
1. Full length PCR amplification of lipase of present application is identified as expected.
2. Full length sequence of the lipase of the present invention

The full length gene fragment is sequenced and registered into Bioweb. The coding region of this cloned the lipase of the present invention includes 1032 base pairs including stop codon as shown in SEQ ID NO: 1.

Identity search showed 44% identity to lipase from Thermomyces lanuginosus (Humicola lanuginosa) or 58% to Acremonium butyri lipase.

### Example 2

### The Purification of the Lipase of the Present Invention

1. The (NH4)2SO4 precipitated proteins are dialysed against 25 mM Tris-HCl buffer (pH 7.0) to a conductivity lower than 1 ms/cm.

2. The dialysed proteins are loaded on a Fast Flow Q column, with a column volume (CV) of 55 ml, and eluted with 25 mM Bis-Tris buffer (pH 7.0) containing 1M NaCl. The fractions with lipase activity on olive oil plate at pH9 are pooled. Two lipase activities are separated in salt gradient 0.056-0.069M and 0.095-0.113M.

3. Lipase fractions, which are eluted from the linear gradient of 0.095-0.113M NaCl on QFF column, are further purified by a Mono Q HR 16/10 column. The lipase fractions are eluted with 25 mM Tris-HCl buffer, pH7.0 with a linear gradient 0.175-0.187M NaCl.

4. Lipase fractions, obtained from Mono Q column, are further purified by a HiLoad 26/60 Superdex 75 (prep grade) column with 25 mM Tris-HCl buffer, pH7.0 containing 0.15M NaCl.

5. Pooled lipase activity from Step 4 is loaded on a MonoQ HR16/10 column, and eluted with 25 mM Tris-HCl buffer, pH8.0 with a NaCl gradient of 0.227-0.238M. The purify of the lipase of the present invention is examined by SDS-PAGE.

13.4 L culture broth is obtained from 278 shake flasks. The total sample volume after dialysis is 600 ml. The SDS-PAGE indicated that the pooled the lipase of the present invention fractions contained one protein band at molecular weight of 29 kD. Totally 9.8mg pure protein is obtained.

### Example 3

### Characterization of the Lipase of the Present Invention

### 1. Determination of Optimum Temperature

The optimum temperature of the lipase of the present invention has been determined as 30° C. by pNP-palmitate (pNPC16) assay as described in ‘Substrate specificity’

### 2. Determination of Optimum pH

The optimum pH of the lipase of the present invention is pH 9 as determined by pNP-palmitate assay as described in ‘Substrate specificity’. The lipase of the present invention showed pH profile similar to the lipase of SEQ ID NO.: 12.

### 3. Substrate Specificity

### Determination of Substrate Specificity:

The substrate specifity of lipase on triglyceride is expressed by a ratio of enzyme activity on pNP-butyrate (pNPC4) and pNP-paltimate (pNPC16) by applying the following steps:

1. Substrate stock: The substrate, pNPC4 or pNPC16, is dissolved in 1-propanol to a final concentration of 16.5 mM.

2. The reaction buffer for pNP-C4 is 50 mM Tris-HCl (pH7.0) containing 0.4% (w/v) Triton X100, 0.1% (w/v) arabic gum, 2 mM EDTA and 2 mM PMSF. The reaction buffer for pNP-C16 is 0.1M glycine (pH9.0), containing 0.4% (w/v) Triton X100, 0.1% (w/v) arabic gum, 2 mM EDTA and 2mM PMSF.

3. The substrate working solution is made up by mixing one volume of stock solution with nine volume of reaction buffer just prior to use.

4. The reaction is started by mixing 20 micro-L sample or blank or control and 150 micro-L of substrate working solution.

5. The reaction is monitored for 5 min by following the absorbance change at 405 nm.

6. The ratio is calculated as mOD/min (pNPC4) divided by mOD/min (pNPC16).

The lipase of the present invention showed low activity on pNP-butyrate (pNPC4) at pH7. The results are listed in Table 1:

TABLE 1

| | The lipase of the present | Lipase with |
|---|---|---|
| | invention | SEQ ID NO.: 12 |
| mOD/min(pNP-butyrate) | 47.46 | 93.86 |
| mOD/min(pNP-paltimate) | 348.93 | 336.86 |
| Ratio(pNPC4/pNPC16) | 0.136 | 0.278 |

### 4. Determination of pH Stability

10 ul of the lipase of the present invention is mixed with 190 ul of buffer. Then the mixed solution is incubated at 30° C. for 5, 10, 20 and 30 minutes respectively. After incubation the lipase activity is assayed using the pNP-palmitate assay (pH9, 30° C.).

When incubated with a buffer, the lipase of the present invention showed that it retained good residual activity in the range of pH 6-10 for at least 30 minutes at 30° C.

| Residual | | | | | |
|---|---|---|---|---|---|
| Activity | pH 6 | pH 7 | pH 8 | pH 9 | pH 10 |
| 5 min | 89% | 88% | 87% | 87% | 90% |
| 10 min | 77% | 73% | 73% | 79% | 82% |
| 20 min | 77% | 72% | 75% | 73% | 82% |
| 30 min | 85% | 81% | 82% | 82% | 84% |

The following buffers are used:

50 mM Bis-Tris, pH 6.0

50 mM Tris-HCl, pH 7.0

50 mM Tris-HCl, pH 8.0

0.1M Glycine, pH 9.0

0.1M Glycine, pH 10.0

### 5. Determination of Thermostability

The residual activity of the lipase of the present invention at pH 10 at different temperatures is listed below in table 2:

TABLE 2

| | Control | 30° C. | 40° C. | 50° C. | 60° C. |
|---|---|---|---|---|---|
| 5 min | 390.53 | 377.13 | 342.27 | 288.33 | 51.67 |
| | | 96.6% | 86.7% | 73.8% | 13.2% |
| 10 min | 390.53 | 373.67 | 320.80 | 230.80 | 4.07 |
| | | 95.7% | 82.1% | 59.1% | 1.0% |
| 15 min | 387.77 | 328.63 | 262.57 | 152.57 | −2.57 |
| | | 84.7% | 67.7% | 39.3% | n.a. |
| 20 min | 387.77 | 325.30 | 256.50 | 139.97 | −1.37 |
| | | 83.9% | 66.2% | 36.1% | n.a. |
| 30 min | 434.27 | 306.07 | 194.27 | 81.93 | −1.00 |
| | | 70.5% | 44.7% | 18.9% | n.a. |

0.1M Glycine buffer is used.

### 6. N-terminal Sequence

The 20 amino acid sequence at N-terminal is AVTVTSQNLANFKFYVQHAT.

### Example 4

### Lipase Activity Determined by Substrate-Agar Assay

Oil emulsion: 50ml olive oil is added into 150 ml 2% PVA (polyvinyl alcohol), then emulsified with Ultra-Turrax.

100ml of 2% agar is mixed with 91ml phosphate citrate buffer (pH 7.0 or 9.0), 8ml oil emulsion and 1 ml of 1% Brilliant Green. The above solutions have been either cooled down or warmed up to 60° C. The mixed solution is poured into petri dishes. After the agar mixture is set, the sample holes (3mm in diameter) are punched in a distance of 1 cm next to each other. 20 micro-L of supernatant is applied in each sample hole, and the plate is incubated at room temperature overnight. The activity is detected as a green zone around the sample hole in the plate.

### Example 5

### AMSA—Automated Mechanical Stress Assay—for Calculation of RP

The enzyme of the present application may be tested using the Automatic Mechanical Stress Assay (AMSA). With the AMSA test the wash performance of a large quantity of small volume enzyme-detergent solutions can be examined. The AMSA plate has a number of slots for test solutions and a lid firmly squeezing the textile swatch to be washed against all the slot openings. During the washing time, the plate, test solutions, textile and lid are vigorously shaken to bring the test solution in contact with the textile and apply mechanical stress. For further description see WO 02/42740 especially the paragraph “Special method embodiments” at page 23-24. The containers, which contain the detergent test solution, consist of cylindrical holes (6 mm diameter, 10 mm depth) in a metal plate. The stained fabric (test material) lies on the top of the metal plates and is used as a lid and seal on the containers. Another metal plate lies on the top of the stained fabric to avoid any spillage from each container. The two metal plate together with the stained fabric are vibrated up and down at a frequency of 30 Hz with an amplitude of 2 mm.

The assay is conducted under the experimental conditions specified below:

TABLE 3

| | |
|---|---|
| Test solution | 0.5 g/l LAS |
| | 0.52 g/l Na2CO3 |
| | 1.07 g/l Zeolite A |
| | 0.52 g/l Na3Citrate |
| Test solution volume | 160 micro l |
| pH | As is (≈9.9) |
| Wash time | 20 minutes |
| Temperature | 30° C. |
| Water hardness | 15°dH |
| | Ratio of Ca²⁺/Mg²⁺/NaHCO₃: |
| | 4:1:7.5 |
| Enzyme concentration in test | 0.125, 0.25, 0.50, 1.0 mg ep/l |
| solution | |
| Drying | Wash performance: After washing |
| | the textile pieces is immediately |
| | flushed in tap water and air-dried at |
| | 85 C in 5 min |
| | Odour: After washing the textile |
| | pieces is immediately flushed in tap |
| | water and dried at room temperature |
| | (20° C.) for 2 hours |
| Test material | Cream turmeric swatch as described |
| | below (EMPA221 used as cotton |
| | textile) |

Cream-turmeric swatches are prepared by mixing 5 g of turmeric (Santa Maria, Denmark) with 100 g cream (38% fat, Arla, Denmark) at 50° C., the mixture is left at this temperature for about 20 minutes and filtered (50° C.) to remove any un-dissolved particles. The mixture is cooled to 20° C. and woven cotton swatches, EMPA221, are immersed in the cream-turmeric mixture and afterwards allowed to dry at room temperature over night and frozen until use.

The performance of the lipase is measured as the brightness of the colour of the textile samples washed with the lipase. Brightness can also be expressed as the intensity of the light reflected from the textile sample when luminated with white light. When the textile is stained the intensity of the reflected light is lower, than that of a clean textile. Therefore the intensity of the reflected light can be used to measure wash performance of an enzyme variant.

Color measurements are made with a professional flatbed scanner (PFU DL2400pro), which is used to capture an image of the washed textile samples. The scans are made with a resolution of 200 dpi and with an output color depth of 24 bits. In order to get accurate results, the scanner is frequently calibrated with a Kodak reflective IT8 target.

To extract a value for the light intensity from the scanned images, a program is used that retrieves the 24 bit pixel values from the image and converts them into values for red, green and blue (RGB). The intensity value (Int) is calculated by adding the RGB values together as vectors and then taking the length of the resulting vector:

Int=\sqrt{r²+g²+b²}

The wash performance (P) of the variants is calculated in accordance with the below formula:

P=Int(v)−Int(r)

where
Int(v) is the light intensity value of textile surface washed with enzyme, and
Int(r) is the light intensity value of textile surface washed without enzyme.

A relative performance score is given as the result of the AMSA wash in accordance with the definition:

Relative Performance scores (RP) are summing up the performances (P) of the tested enzyme variants against the reference enzyme (SEQ ID NO: 12):

RP=P(test enzyme)/P(reference enzyme).

RPavg indicates the average relative performance compared to the reference enzyme at all three enzyme concentrations (0.125, 0.25, 0.5, 1.0 mg ep/l)

RPavg=avg(RP(0.125), RP(0.25) RP(0.5), RP(1.0))

A lipase is considered to exhibit improved wash performance, if it performs better than the reference.

### Example 6

### GC—Gas Chromatograph—for calculation of risk factor.

The butyric acid release from the lipase washed swatches are measured by Solid Phase Micro Extraction Gas Chromatography (SPME-GC) using the following method: Four textile pieces (5 mm in diameter), washed in the specified solution in Table 1 containing 1 mg/L lipase, are transferred to a Gas Chromatograph (GC) vial. The samples are analysed on a Varian 3800 GC equipped with a Stabilwax-DA w/Integra-Guard column (30m, 0.32 mm ID and 0.25 micro-m df) and a Carboxen PDMS SPME fibre (75 micro-m). Each sample is pre-incubated for 10 minutes at 40° C. followed by 20 minutes sampling with the SPME fibre in the head-space over the textile pieces. The sample is subsequently injected onto the column (injector temperature =250° C.). Column flow =2 ml Helium/min. Column oven temperature gradient: 0 min =40° C., 2 min =40° C., 22 min =240° C., 32 min =240° C. The butyric acid is detected by FID detection and the amount of butyric acid is calculated based on a butyric acid standard curve.

The Risk Performance Odour, R, of a lipase variant is the ratio between the amount of released butyric acid from the lipase of the invention washed swatch and the amount of released butyric acid from a swatch washed with the mature part of the reference lipase, after both values have been corrected for the amount of released butyric acid from a non-lipase washed swatch. The risk (R) of the variants is calculated in accordance with the below formula:

Odour 32 measured in ug buturic acid developed at 1 mg enzyme protein/1 corrected for blank

α_{test enzyme}=Odour_{test enzyme}−Blank

α_{reference enzyme}=Odour_{reference enzyme}−Blank

R=α_{test enzyme}/α_{reference enzyme}

A variant is considered to exhibit reduced odor compared to the reference (SEQ ID NO: 12): if the R factor is lower than 1.

### Example 7

### AMSA—Automated Mechanical Stress Assay—Results for Wash Performance and Odour

A lipase enzyme of the present application was tested using the Automatic Mechanical Stress Assay (AMSA) in four different test solutions A), B), C), and D) in different concentrations of the enzyme. The assays for solutions A), B), C), and D) were conducted under the following experimental conditions:

| | |
|---|---|
| Test solutions A, B and C | A) 25 mM Glycine + 2 mM CaCl₂ |
| | (pH 8) |
| | B) 25 mM Glycine + 2 mM CaCl₂ |
| | (pH 9) |
| | C) 25 mM Glycine + 2 mM CaCl₂ |
| | (pH 10) |
| Test solution volume | 160 micro l |
| Wash time | 20 minutes |
| Temperature | 25° C. |
| Test enzyme (SEQ ID NO: 2) | 0.25, 0.5, 1.0, 2.0 mg enzyme protein |
| | per liter (ep/l) |
| Reference enzyme (SEQ ID | 1.0 mg ep/l and 2.0 mg ep/l |
| NO: 12) | |
| Drying | For calculating wash performance: |
| | After washing the textile pieces they |
| | were immediately flushed in tap |
| | water and air-dried at 85° C. for 5 |
| | minutes. |
| | For calculating Odor: |
| | After washing the textile pieces they |
| | were immediately flushed in tap |
| | water and dried at room temperature |
| | (20° C.) for 2 hours |
| Test material | Cream turmeric swatch as described |
| | below (EMPA221 used as cotton |
| | textile) |
| Test solution D | D) Commercial US liquid type |
| | detergent 0.79 g/L in water |
| Test solution volume | 160 micro l |
| pH | Not measured; given by the test |
| | solution |
| Wash time | 20 minutes |
| Temperature | 30° C. |
| Water hardness | 6°dH |
| | Ratio of Ca²⁺/Mg²⁺/NaHCO₃: |
| | 2:1:4.5 |
| Test enzyme (SEQ ID NO: 2) | 0.25, 0.5, 1.0, 2.0 mg enzyme protein |
| concentration in test solution | per liter (ep/l) |
| Reference enzyme (SEQ ID | 1.0 mg ep/l and 2.0 mg ep/l |
| NO: 12) | |
| Drying | For calculating wash performance: |
| | Same as for solution A, B and C. |
| | For calculating odor: |
| | Same as for solution A, B and C. |
| Test material | Cream turmeric swatch as described |
| | below (EMPA221 was used as cotton |
| | textile) |

Cream-turmeric swatches were prepared by mixing 5 g of turmeric (Santa Maria, Denmark) with 100 g cream (38% fat, Arla, Denmark) at 50° C. The mixture was kept at this temperature for about 20 minutes and filtered (50° C.) to remove any un-dissolved particles. The mixture was cooled to 20° C. and woven cotton swatches, EMPA221, were first immersed in the cream-turmeric mixture and then allowed to dry at room temperature over night. The swatches were then frozen until use.

The EMPA swatches were obtained from Eidgenössische Materialprüfungs- und Forschungsanstalt- Testmaterials, Mövenstrasse 12, CH-9015 St.Gallen, Switzerland.

Color measurements were measured on the dried swatches and wash performance calculated as described in example 5. The relative performance score (RP) was calculated against the reference enzyme (SEQ ID NO: 12).

The butyric acid release from the dried swatches was measured using GC in accordance with example 6 and compared to the reference lipase (SEQ ID NO: 12). The Risk Performance Odour, R, of the test lipase enzyme and the reference was calculated Results;

| | | |
|---|---|---|
| Test solution A: | RP = 0.8 | R = 0.2 |
| Test solution B: | RP = 0.9 | R = 0.9 |
| Test solution C: | RP = 0.5 | R = 0.5 |
| Test Solution D: | RP = 0.5 | R = 0.1 |

### Example 8

### BR—Benefit Risk

The Benefit Risk factor describing the performance compared to the reduced risk for odour smell is thus defined as:

BR=RP_{avg}/R

A lipase is considered to exhibit improved wash performance and reduced odor, if the BR factor is higher than 1.

### Example 9

### The Expression and the Characterization of the Lipase of the Present Invention:

A standard PCR reaction is run using the plasmid DSM 17467 as template and oligo 300305J7 and 200405j1:

(SEQ ID NO: 16)

| | |
|---|---|
| Oligo | gccggcggccgcacaatgcgtcttctccctgccctctc |
| 300305j7: | |

(SEQ ID NO: 17)

| | |
|---|---|
| Oligo | tcgcggcgcgccctagttagccactgctcctttc |
| 200405j1: | |

The PCR fragment and the Aspergillus expression plasmid pENI2516 (the method for constructing is described in WO 2004/069872-A1, the disclosures of which are incorporated by reference in their entireties.) are cut with restriction enzyme NotI and AscI, purified from gel and ligated according to the standard procedure known by one skilled in the art. The screening for the plasmid DNA is also within the general knowledge of one skilled in the art.

The resulting plasmid is control-sequenced and named pENI4063. The plasmid is transformed into the filamentous fungi Aspergillus oryzae using standard technique (cf. WO 2004/069872-A1). The resulting transformants are screened for lipase expression using para-nitrophenyl-valerate (PNP-valerate). The lipase hydrolysed the carboxylic ester bond, which released PNP. PNP turned yellow, which is detectable by eye.

The transformant giving the highest yellowness is chosen for further fermentation and subsequent purification of the lipase (see previous examples).

### Example 10

### The Characterization of the Lipase of the Present Invention

AMSA on Cream/Turmeric swatch is performed in the absence of detergent, but in the presence of 25mM Glycine buffer with pH7, 8, 9, and 10, respectively, to evaluate the expressed lipases of present invention.

The result showed that the expressed lipase of present invention performs like the reference enzyme (SEQ ID NO: 12) in AMSA on Cream/Turmeric swatch at pH 7. At pH 8, the expressed lipase of the present invention shows wash performance. At pH 9, the expressed lipase of present invention performs like the reference enzyme (SEQ ID NO: 12) and at pH 10 the lipase of the present invention has an RPwash of 0.7 when compared to the reference lipase.

Odour measurement of the lipase of present invention after wash in 25 mM Glycine buffer (pH 9) at 1 ppm (RPwash of about 1) reveals an RPodour of about 2.4 compared to the reference lipase (SEQ ID NO: 12).

### Deposit of Biogoical Materail

The lipase of the present invention is a lipase which can be purified from the fungal strain Nectria sp. A wild type strain of this species, collected for the applicant by The Institute of Microbiology, Chinese Academy of Science, was found on dead branches of unidentified plant, in Yunnan Province, China in 1999. The inventors have also cloned the gene encoding a lipase of the invention into a strain of E. coli harboring strain deposited it under the terms of the Budapest Treaty on 21 Jul. 2005 as DSM 17467. The harboring strain was deposited at Deutsche Sammlung von Mikroorganismen und Zellkulturen GmbH, Mascheroder Weg 1b, D-38124 Braunschweig, Germany by Novozymes (China) Investment Co. Ltd.; China Headquarters; 14 Xinxi Road; Shangdi Zone; Haidian District; 100085 Beijing; China on behalf of the applicant. The deposit was made under the terms of the Budapest Treaty on the International Recognition of the Deposits of Microorganisms for the Purpose of Patent Procedures. The deposit was accorded the following number and date:

| Deposit | Accession Number | Date of Deposit |
|---|---|---|
| DSM | 17467 | 21-JULY-2005 |

The strain has been deposited under conditions that assure that access to the culture will be available during the pendency of this patent application to one determined by relevant patent authorities to be entitled thereto. The deposit represents a substantially pure culture of the deposited strain. The deposit is available as required by foreign patent laws in countries wherein counterparts of the subject application or its progeny are filed. However, it should be understood that the availability of a deposit does not constitute a license to practice the subject invention in derogation of patent rights granted by governmental action.

The invention described and claimed herein is not to be limited in scope by the specific aspects herein disclosed, since these aspects are intended as illustrations of several aspects of the invention. Any equivalent aspects are intended to be within the scope of this invention. Indeed, various modifications of the invention in addition to those shown and described herein will become apparent to those skilled in the art from the foregoing description. Such modifications are also intended to fall within the scope of the appended claims. In the case of conflict, the present disclosure including definitions will control.

Various references are cited herein, the disclosures of which are incorporated by reference in their entireties.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A detergent composition comprising an isolated polypeptide having lipase activity selected from the group consisting of:
(a) a polypeptide comprising an amino acid sequence having at least about 60% identity to the mature polypeptide of SEQ ID NO: 2;
(b) a polypeptide having an amino acid sequence which has at least about 60% identity with amino acids 1 to 315 of SEQ ID NO: 2;
(c) a polypeptide encoded by a polynucleotide that hybridizes under at least low stringency conditions with (i) the mature polypeptide coding sequence of SEQ ID NO: 1, (ii) the cDNA sequence contained in or the genomic DNA sequence comprising the mature polypeptide coding sequence of SEQ ID NO: 1, or (iii) a full-length complementary strand of (i) or (ii);
(d) a polypeptide which is encoded by a polynucleotide which hybridizes under at least low stringency conditions with (i) nucleotides 41 to 1069 of SEQ ID NO: 1, (ii) the cDNA sequence contained in or the genomic DNA sequence comprising nucleotides 41 to 1069 of SEQ ID NO: 1, or (iii) a full-length complementary strand of (i) or (ii);
(e) a polypeptide which is encoded by a polynucleotide which hybridizes under at least low stringency conditions with nucleotides 41 to 1069 of SEQ ID NO: 1, or a complementary strand of nucleotides 41 to 1069 of SEQ ID NO: 1;
(f) a polypeptide encoded by a polynucleotide comprising a nucleotide sequence having at least about 60% identity to the mature polypeptide coding sequence of SEQ ID NO: 1;
(g) a polypeptide derived from SEQ ID NO:2 by substitution, deletion or addition of one or more amino acids;
(h) a polypeptide which has at least about 60% identity with the polypeptide encoded by the polynucleotide contained in the plasmid which is contained in E. Coli DSM 17467,
and wherein the composition comprises a detergent ingredient.

2. A detergent composition according to claim 1, wherein the polypeptide comprises an amino acid sequence having at least about 65%, 70%, 75%, 80%, 85%, 90% or 95% identity to the mature polypeptide of SEQ ID NO: 2.

3. A detergent composition according to claim 1, wherein the polypeptide comprises or consists of the mature polypeptide of SEQ ID NO: 2; or a fragment thereof having lipase activity.

4. A detergent composition according to claim 1, wherein the polypeptide has an amino acid sequence which has at least about 80% identity, such as 85% identity with amino acids 1 to 315 of SEQ ID NO: 2.

5. A detergent composition according to claim 1, wherein the polypeptide has an amino acid sequence which has at least about 90% identity, such as 95% identity with amino acids 1 to 315 of SEQ ID NO: 2.

6. A detergent composition according to claim 1, wherein the polypeptide comprises or consists of the amino acids 1 to 315 of SEQ ID NO: 2; or a fragment thereof having lipase activity.

7. A detergent composition according to claim 1, wherein the polypeptide is encoded by a polynucleotide that hybridizes under at least medium stringency, at least medium-high stringency or at least high stringency conditions with (i) the mature polypeptide coding sequence of SEQ ID NO: 1, (ii) the cDNA sequence contained in or the genomic DNA sequence comprising the mature polypeptide coding sequence of SEQ ID NO: 1, or (iii) a full-length complementary strand of (i) or (ii).

8. A detergent composition according to claim 1, wherein the polypeptide is encoded by a polynucleotide comprising a nucleotide sequence having at least about 65%, 70%, 75%, 80%, 85%, 90% or 95% identity to the mature polypeptide coding sequence of SEQ ID NO: 1

9. A detergent composition according to claim 1, wherein the polypeptide is encoded by a polynucleotide comprising or consisting of the nucleotide sequence of SEQ ID NO: 1; or a subsequence thereof encoding a fragment having lipase activity.

10. A detergent composition according to claim 9, wherein the polypeptide is encoded by a polynucleotide comprising or consisting of the mature polypeptide coding sequence of SEQ ID NO: 1.

11. A detergent composition according to claim 9, wherein the polypeptide is encoded by a polynucleotide comprising or consisting of the nucleotide sequence of SEQ ID NO: 1

12. A detergent composition according claim 1 wherein the level of detergent ingredient in the composition is from about 0.1 to about 40%.

13. A detergent composition according to claim 1 wherein the anionic surfactant is an alkoxylated alkyl sulphate.

14. A detergent composition according to claim 1 wherein the detergent ingredient comprises from about 5 to about 30% aluminosilicate and/or phosphate builder.

15. A detergent composition according to claim 1 wherein the detergent ingredient comprises a source of peroxide and a bleach activator.

16. A detergent according to claim 1 which is a liquid detergent composition or a solid detergent composition.

17. A detergent according to claim 1 which is a unit dose composition, either a solid tablet or a liquid encapsulated in a soluble film.

18. A washing process comprising laundering textile articles in an aqueous solution comprising the detergent composition according to claim 1.

19. A washing process according to claim 18 to of removing soils and stains from a surface comprising the steps of:
(a) optionally pretreating the soils and stains with the composition of claim 1 to form an optionally pretreated surface;
(b) adding an effective amount of the composition of claim 1 to water to form from an aqueous washing solution comprising about 500 to about 10000 ppm of the composition;
(c) contacting the aqueous washing solution with the optionally pretreated surface, and
(d) optionally providing agitation to the aqueous washing solution and the optionally pretreated surface.

20. A washing process according claim 18, in which the aqueous solution is at a temperature below about 30° C.


SEQUENCE LISTING (17 sequences)

SEQ ID NO: 1 - DNA, 1219 bp, Nectria sp.
  CDS (41)..(1069)
  sig_peptide (41)..(124)
  mat_peptide (125)..(1069)
acaggacccctagacttgtgtaactctcctgattctcacaatgcgtcttctccctgccctctccgtggtcggcgttgccagcgctgcctccatcaagagctatcttcatgcctttgaggagcgagctgttactgtgacctcccagaacctcgcaaacttcaagttctacgtccagcatgccactgccgcgtactgtaactacgaccgcgcagctggagccttgatttcatgctcgagcaactgcccaagtattgaaagcaatgctgctaagattgtgggatccttcggaggcgaggatacgggcattgcaggctacgtctcaactgacgcaactcgcaaggagattgtcgtctctatccgtggcagtattaacgtccgcaactggatcacaaacctcgacttcgtctggagttcctgctcagatctgtcgagcaactgcaaggcccacgctggcttcaaagatgcttgggatgagatctccaccgctgccaaagctgcagtcgtctcggcgaagaaggccaacccaagctacaccatcgtcgccacgggacactcccttggtggtgctgttgctaccttagcagctgcttacatccgagctgctggatatagtgtcgatctgtacacgttcggctcgccacgtgtaggaaatgactacttcgccaacttcgtcaccagccaagccggagctgaataccgcgtgacacacctcgacgaccctgttcctcgtcttccacccatcctctttggctaccgtcatacgtctcctgagtactggctgtcaaacggaggcgctactacgacgacctatagtctgtcagacatcgtggtatgcgagggtatcgccaacaccgactgcaatgccggcacgcttggccttgatattattgcccacctcatatacttccaggatacttcggcatgcaacaccggattcacgtggaagcgcgacacgttgtcggatgcagagctcgaggagatggtgaacaagtgggctgagcaggatgtcgaatacgtcgccaatttgacgacgaccgcgtcgaagcgatggaaaggagcagtggctaactagccatgatatcttgggaagtttacttcttggaaagcagtggatgaaagtaccttatgatcacattgaagcaatgaacttacaatgataacgtacataaataaattgtctcgagagagtcaaacgtctaaatgaaaaaaaaaaaaaaaa

SEQ ID NO: 2 - protein, 343 aa, Nectria sp.
MRLLPALSVVGVASAASIKSYLHAFEERAVTVTSQNLANFKFYVQHATAAYCNYDRAAGALISCSSNCPSIESNAAKIVGSFGGEDTGIAGYVSTDATRKEIVVSIRGSINVRNWITNLDFVWSSCSDLSSNCKAHAGFKDAWDEISTAAKAAVVSAKKANPSYTIVATGHSLGGAVATLAAAYIRAAGYSVDLYTFGSPRVGNDYFANFVTSQAGAEYRVTHLDDPVPRLPPILFGYRHTSPEYWLSNGGATTTTYSLSDIVVCEGIANTDCNAGTLGLDIIAHLIYFQDTSACNTGFTWKRDTLSDAELEEMVNKWAEQDVEYVANLTTTASKRWKGAVAN

SEQ ID NO: 3 - DNA, 24 bp, Nectria sp.
tccagacgaagtcgaggtttgtga

SEQ ID NO: 4 - DNA, 24 bp, Nectria sp.
tactgccacggatagagacgacaa

SEQ ID NO: 5 - DNA, 24 bp, Nectria sp.
aatgcccgtatcctcgcctccgaa

SEQ ID NO: 6 - DNA, 22 bp, Nectria sp.
aacaggacccctagacttgtgt

SEQ ID NO: 7 - DNA, 20 bp, Nectria sp.
taactctcctgattctcaca

SEQ ID NO: 8 - DNA, 17 bp, Nectria sp.
  misc_feature: n is a, c, g or t
  misc_feature (9)..(9): n is a, c, g, or t
  misc_feature (12)..(12): n is a, c, g, or t
cadaayytngcnaaytt

SEQ ID NO: 9 - DNA, 20 bp, Nectria sp.
  misc_feature (12)..(12): n is a, c, g, or t
aayttytaygtncadcaygc

SEQ ID NO: 10 - DNA, 20 bp, Nectria Sp.
  misc_feature
aggttggcdgcdccctcaca

SEQ ID NO: 11 - DNA, 20 bp, Nectria Sp.
gwwgtgtgccdgtatccaaa

SEQ ID NO: 12 - protein, 274 aa, Thermomyces lanuginosus
SPIRREVSQDLFNQFNLFAQYSAAAYCGKNNDAPAGTNITCTGNACPEVEKADATFLYSFEDSGVGDVTGFLALDNTNKLIVLSFRGSRSIENWIGNLNFDLKEINDICSGCRGHDGFTSSWRSVADTLRQKVEDAVREHPDYRVVFTGHSLGGALATVAGADLRGNGYDIDVFSYGAPRVGNRAFAEFLTVQTGGTLYRITHTNDIVPRLPPREFGYSHSSPEYWIKSGTLVPVRRRDIVKIEGIDATGGNNQPNIPDIPAHLWYFGLIGTCL

SEQ ID NO: 13 - protein, 12 aa, Artificial sequence
  synthetic sequence
ACMSHTWGERNL

SEQ ID NO: 14 - protein, 14 aa, Artificial sequence
  synthetic sequence
HGWGEDANLAMNPS

SEQ ID NO: 15 - protein, 20 aa, Nectria sp.
AVTVTSQNLANFKFYVQHAT

SEQ ID NO: 16 - DNA, 38 bp, Artificial
  oligo for PCR
  misc_feature (1)..(38)
gccggcggccgcacaatgcgtcttctccctgccctctc

SEQ ID NO: 17 - DNA, 34 bp, Artificial
  oligo for pcr
  misc_feature (1)..(34)
tcgcggcgcgccctagttagccactgctcctttc